(19) United States
(12) Patent Application Publication
(10) Pub. No.: US 2009/0074247 A1
(43) Pub. Date: Mar. 19, 2009

(54) Obstacle detection method

(76) Inventors: Guanglin Ma, Shanghai (CN); Ing Su-Birm Park, Aldenhoven (DE); Alexander Ioffe, Bonn (DE)

Correspondence Address: DELPHI TECHNOLOGIES, INC., M/C 480-410-202, PO BOX 5052, TROY, MI, 48007, US

(21) Appl. No.: 12/283,492

(22) Filed: Sep. 12, 2008

(30) Foreign Application Priority Data
Sep. 13, 2007 (EP) 07017986.6

(51) Int. Cl. G06K 9/62

(52) U.S. Cl. 382/103

(57) ABSTRACT

A method is provided for the detection of an obstacle in a road, in particular of a pedestrian, in the surroundings in the range of view of an optical sensor attached to a movable carrier such as in particular a vehicle, wherein a first image is taken by means of the optical sensor at a first time and a second image is taken at a later second time, a first transformed image is produced by a transformation of the first taken image from the image plane of the optical sensor into the road plane, a further transformed image is produced from the first transformed image while taking account of the carrier movement in the time period between the first time and the second time, the further transformed image is transformed back from the road plane into the image plane and an image stabilization is carried out based on the image transformed back into the image plane and on the second taken image.

### TECHNICAL FIELD

The invention relates to a method for the detection of an obstacle in a road, in particular a pedestrian, in the surroundings in the range of view of an optical sensor attached to a movable carrier such as in particular a vehicle.

### BACKGROUND OF THE INVENTION

In particular the risk of collisions with pedestrians in road traffic should be reduced by such methods.

The use of cameras in vehicles for the corresponding monitoring of the surroundings is already known. However, the amount of image data to be processed and the automatic evaluation of the images produced proves to be problematic in this connection. The images taken thus suffer from noise as a rule which can in particular be caused by the vehicle's own movement and possible road bumpiness, a vehicle tilt, vehicle vibrations and/or the like. The correspondingly complex and/or expensive image processing in particular brings along problems when the evaluation of image material has to take place not only automatically, but also particularly fast such as is required, for example, in a vehicle safety system for the protection of persons on a collision.

### SUMMARY OF THE INVENTION

It is the underlying object of the invention to provide a possibility to reduce the computing effort on the detection of obstacles in a road, such as in particular pedestrians, and/or to increase the robustness of such a detection.

In accordance with the invention, this object is satisfied by a method for the detection of an obstacle in a road, in particular of a pedestrian, in the surroundings in the range of view of an optical sensor attached to a movable carrier such as in particular a vehicle, wherein a first image is taken by means of the optical sensor at a first time and a second image is taken at a later second time, a first transformed image is produced by a transformation of the first taken image from the image plane of the optical sensor into the road plane, a further transformed image is produced from the first transformed image while taking account of the carrier movement in the time period between the first time and the second time, the further transformed image is transformed back from the road plane into the image plane and an image stabilization is carried out based on the image transformed back into the image plane and on the second taken image.

Unlike the previously usual practice, in accordance with which the image stabilization algorithm is applied to two mutually sequentially taken original images, the image stabilization takes place in accordance with the invention based on an image transformed back from the road plane into the image plane and on an image taken at a late time, with the carrier movement or vehicle movement already having been taken into account on the production of the image transformed back. Only a noise movement therefore still has to be compensated using the image stabilization algorithm which is caused by possible road bumpiness, a carrier inclination, carrier vibrations and/or the like.

The first transformed image is preferably transformed into the later second time for the production of the further transformed image while taking account of the carrier movement, in particular the carrier speed and/or the carrier yaw speed.

It is in particular also of advantage for the carrier movement, in particular the carrier speed and/or carrier yaw speed, to be taken into account in the production of the further transformed image by a corresponding translation and/or rotation of the first transformed image.

As already mentioned, problems caused by possible road bumpiness, a carrier inclination, carrier vibrations and/or the like can in particular be compensated using the image stabilization.

In the image stabilization, a respective edge image is expediently produced from the image transformed back and the second taken image.

In this connection, a movement vector can be calculated from the edge images obtained for the image transformed back and the second taken image and this movement vector can be used for the problem compensation. In this connection, the movement vector can, for example, be corrected by a Kalman filtering and the correspondingly corrected movement vector can be used for the problem compensation.

A camera, in particular a video camera, is preferably used as the optical sensor.

A mono-camera is preferably used as the optical sensor.

A subject of the invention is furthermore a computer program with programming code means to carry out the method described above when the program is carried out on a computer or on a corresponding computing unit.

A computer program product is also a subject of the invention having programming code means stored on a computer readable data carrier to carry out the method described above when the computer program is carried out on a computer or on a corresponding computing unit.

In this connection, a computer is understood as any desired data processing device with which the method can be carried out. In this connection, such a data processing device can in particular include digital signal processors and/or microprocessors with which the method can be carried out in full or in parts.

Finally, a device for the detection of an obstacle in a road, in particular of a pedestrian, in the surroundings in the range of view of an optical sensor attached to a movable carrier such as in particular a vehicle, having a data processing system which is designed for the carrying out of the method described above is also a subject of the invention.

### BRIEF DESCRIPTION OF THE DRAWINGS

The invention will be explained in more detail in the following with reference to embodiments and to the drawing; there are shown in this:

FIG. 1 is the transformation of a taken image from the image plane into the road plane;

FIG. 2 is a background subtraction in the vehicle plane;

FIG. 3 is a back transformation of the result obtained by the background subtraction in the road plane from the road plane into the image plane;

FIG. 4 is a simplified flowchart including the transformation into the road plane, a transformation taking place in the road plane and the transformation back into the image plane;

FIG. 5 is a simplified flowchart of the obstacle detection including image stabilization; and

FIG. 6 is a schematic representation of an exemplary image stabilization process.

### DESCRIPTION OF THE PREFERRED EMBODIMENT

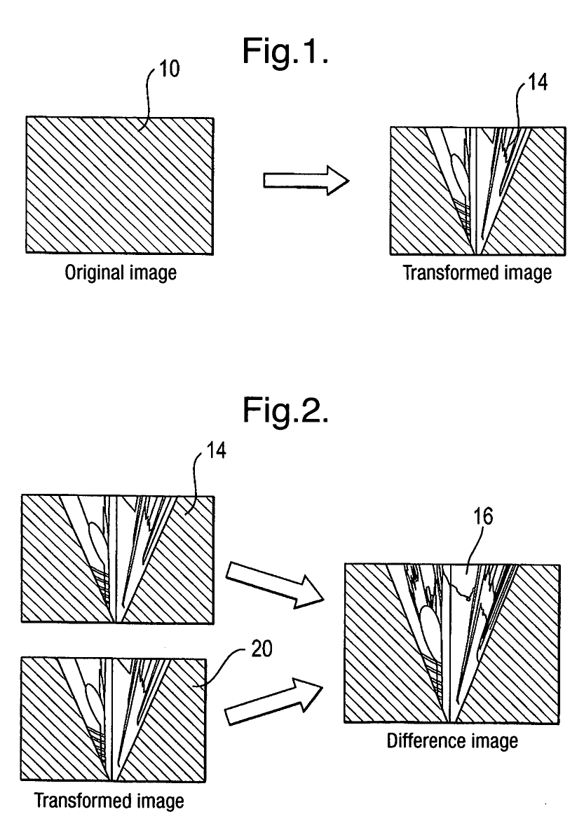

FIGS. 1 to 6 show an exemplary embodiment of a method for the detection of an obstacle in a road, in particular of a pedestrian, in the surroundings in the range of view of an optical sensor attached to a movable carrier such as in particular a vehicle.

In this connection, a first image 10 is taken by means of the optical sensor at a first time T-1 and a second image 12 is taken at a time T. These taken images are therefore original images. A first transformed image 14 is produced by a transformation of the first taken image 10 from the image plane of the optical sensor into the road plane. A further transformed image 16 is produced from the first transformed image 14 while taking account of the carrier movement in the time period between the first time T-1 and the second time T. The further transformed image 16 is transformed back from the road plane into the image plane. An image stabilization is then carried out based on the image 18 transformed back into the image plane and on the second taken image 12.

As already mentioned, the movable carrier can in particular be a vehicle. The method can then in particular serve for the detection of pedestrians. A camera, in particular a video camera, can be used as the optical sensor, for example, with a mono-camera preferably being used.

FIG. 1 shows the transformation of the first taken image 10 from the image plane of the optical sensor into the road plane, whereby the first transformed image 14 is produced.

It generally applies that the pixels in the two-dimensional image plane of the optical sensor or camera receive light signals from three-dimensional surroundings so that the exact three-dimensional position corresponding to a respective pixel cannot be determined without additional conditions. For the optical sensor installed at a vehicle, the light signals received pixel-wise correspond to the road to or to obstacles, with a respective object having to be recognized as an obstacle if its vertical coordinate (height) differs from the vertical coordinate of the road.

It is presumed in the algorithm used for the present obstacle detection that the road plane is ideally completely planar and horizontal. Based on this assumption, the image plane is transformed into a plan view of the road plane, whereby a type of map is prepared.

FIG. 2 shows an exemplary background subtraction in the vehicle plane. It is then possible, for example, for two sequential map-like transformed images, to calculate the overlap region for these two images using the carrier movement or vehicle movement and to carry out a background subtraction for the overlap region, whereby a difference image is obtained.

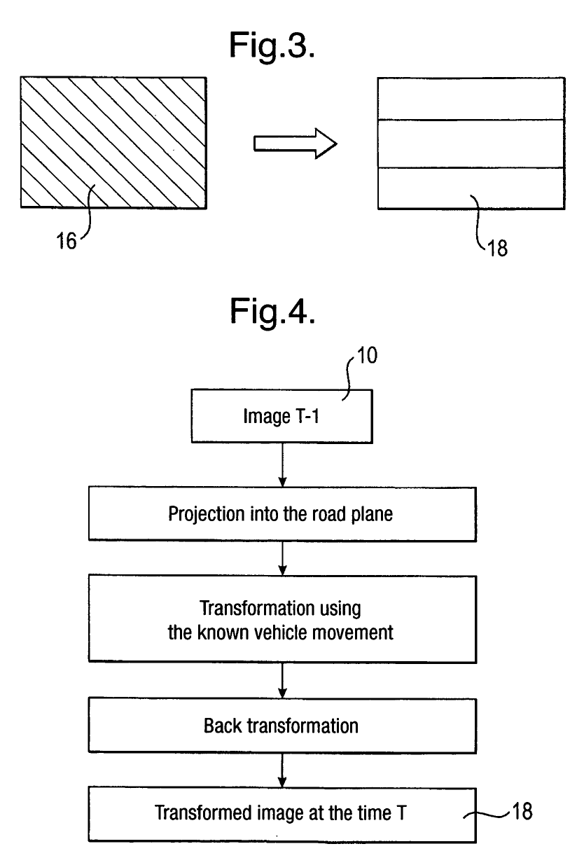

The result of the subtraction can be brought into a binary form by comparison with a threshold value. The result brought into a binary form corresponds to detected obstacles in the road plane. The result of this obstacle detection is transformed from the road plane back into the image plane to locate the corresponding obstacles in the image plane, as is shown in FIG. 3. In this FIG. 3, the rear transformation of the result obtained by the background subtraction in the road plane from the road plane to the image plane is shown.

The difference image recognizable in FIG. 2 can in particular be the further transformed image 16. In this connection, in particular such an embodiment of the method is conceivable in which the first transformed image 14 is transformed into the later second time T for the production of the this further transformed image 16 while taking account of the carrier movement, in particular the carrier speed and/or the carrier yaw speed. The further transformed image 16 can then be produced, for example by a corresponding difference image, from the first transformed image 14 and the transformed image 20 obtained from the transformation into the second time T.

The carrier movement, in particular the carrier speed and/or carrier yaw speed, can be taken into account by a corresponding translation and/or rotation of the first transformed image 14.

Since the initial detection described with reference to FIGS. 1 to 3 is based on the assumption that the road plane is ideally completely planar and horizontal and since the road plane can, however, actually contain bumps, the detection result suffers from noise. The bumpiness of the road plane can also cause inclination movements of the vehicle, which forms the carrier here, which likewise effects a detection suffering from noise.

A corresponding image stabilization can now take place in the two-dimensional image plane for the compensation of these problems of a detection suffering from noise caused by the inclination movements of the vehicle. In this connection, a preceding image can generally, for example, be correspondingly stabilized by comparison with a subsequent image.

Such an image stabilization takes place in accordance with the invention based on the image 18 transformed back into the image plane and on the second taken image 12.

FIG. 4 shows a simplified flowchart including the transformation into the road plane, the transformation taking place in the road plane and the transformation back into the image plane. The image 10 taken at the first time T-1 is then projected into the road plane, the obtained first transformed image 14 is transformed into the later second time T while taking account of the vehicle movement, in particular the vehicle speed and/or the vehicle yaw speed and the further transformed image 16 optionally obtained after a subtraction is transformed back into the image plane. An image transformed from the time T-1 into the time T is therefore now present in this image plane.

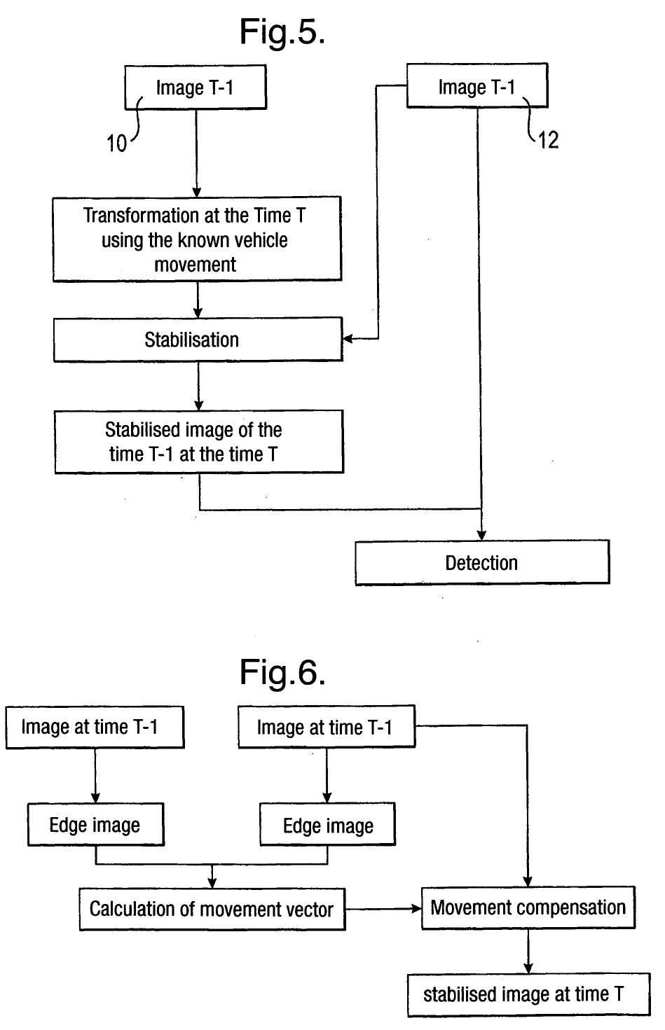

FIG. 5 shows a simplified flowchart of the obstacle detection, including image stabilization.

The first image 10 taken at the first time T-1 is then projected into the road plane. In the road plane, the obtained first transformed image for the time T-1 is transformed into the later second time T while taking account of the known vehicle movement (speed and yaw rate). Finally, the obtained further transformed image 16 is transformed back from the road plane into the image plane of the optical sensor. The corresponding image of the shot at the time T-1 for the time T is obtained as the result (cf. also FIG. 8 again). Finally, the image stabilization takes place on the basis of the image 18 transformed back into the image plane and of the second image 12 taken at the later second time T. The known vehicle movement is first compensated in this manner, whereas the image stabilization taking place thereafter only takes place for the compensation of movement noise which is caused by the vehicle inclination, possible road bumpiness, etc.

FIG. 6 shows an exemplary image stabilization process in a schematic representation.

Two sequential images can then be transferred into binary images by means of a corresponding filtering to obtain edge information as well as an essential center frequency content in the comparatively clearer parts of the image.

In the next step, a movement sector is calculated in that non-coinciding points of two sequential binary or edge images are measured. The movement sector can be corrected by a Kalman filtering, whereupon the image can be compensated while using the corrected movement vector.

Such a procedure in particular works when the optical sensor, for example a camcorder, vibrates in a fixed position. In the present case, the optical sensor or the camera can be attached to a moving vehicle. In this connection, the difference of the two sequential images is caused not only by the vibration of the optical sensor, but also by depth changes occurring due to the vehicle movement. This vehicle movement is now, however, already compensated in that the first transformed image 14 was produced by the transformation of the first taken image 10 from the image plane of the optical sensor into the road plane, the further transformed image 16 was produced from the first transformed image 14 while taking account of the vehicle movement in the time period between the first time T-1 and the second time T and the further transformed image 16 was transformed back from the road plane into the image plane. As already mentioned, in accordance with the invention, the image stabilization then takes place based on the image 18 transformed back into the image plane and on the second taken image 12.

1. A method for detection of a pedestrian in a road in a surroundings in a range of view of an optical sensor attached to a vehicle, comprising
taking a first image using the optical sensor at a first time and a second image at a later second time;
producing a first transformed image by a transformation of the first image from an image plane of the optical sensor into a road plane;
producing a further transformed image from the first transformed image while taking account vehicle movement in a time period between the first time and the second time;
transforming the further transformed image back from the road plane into the image plane; and
carrying out an image stabilization based on the further transformed image transformed back into the image plane and on the second taken image.

2. A method in accordance with claim 1, characterized in that the first transformed image is transformed into the later second time for the production of the further transformed image while taking account of vehicle movement including vehicle speed or vehicle yaw speed.

3. A method in accordance with claim 1, characterized in that vehicle movement includes vehicle speed or vehicle yaw speed and is taken into account in the production of the further transformed image by a corresponding translation or rotation of the first transformed image.

4. A method in accordance with claim 1, characterized in that the image stabilization compensates for road bumpiness, vehicle inclination, or vehicle vibrations.

5. A method in accordance with claim 1, further comprising producing a respective edge image in the image stabilization from the back transformed image and the second taken image.

6. A method in accordance with claim 5, further comprising calculating a movement vector from the edge image obtained for the further transformed image transformed back into the image plane and the second taken image, and using the movement vector for compensation of the further transformed image.

7. A method in accordance with claim 6, characterized in that the movement vector is corrected by a Kalman filtering and the corrected movement vector is used for the compensation.

8. A method in accordance with claim 1 wherein the optical sensor is a video camera.

9. A method in accordance with claim 8, wherein the video camera is a mono-camera.

10. A computer program comprising computer readable instructions effective to configure a microprocessor to carry out a method for detection of a pedestrian in a road in a range of view of an optical sensor attached to a vehicle, said method comprising
receiving from an optical sensor a first image at a first time and a signal corresponding to a second image at a later second time;
producing a first transformed image by a transformation of the first image from an image plane of the optical sensor into a road plane;
producing a further transformed image from the first transformed image while taking account vehicle movement in a time period between the first time and the second time;
transforming the further transformed image back from the road plane into the image plane; and
carrying out an image stabilization based on the further transformed image transformed back into the image plane and on the second taken image.

11. An apparatus for detection of a pedestrian in a road, said apparatus comprising
an optical sensor attached to a vehicle and adapted to take a first image at a first time and a second image at a later second time; and
a data processing device for receiving the first image and the second image and configured to carry out a method for detection of a pedestrian in a road in a range of view of the optical sensor, said method comprising
producing a first transformed image by a transformation of the first image from an image plane of the optical sensor into a road plane;
producing a further transformed image from the first transformed image while taking account vehicle movement in a time period between the first time and the second time;
transforming the further transformed image back from the road plane into the image plane; and
carrying out an image stabilization based on the further transformed image transformed back into the image plane and on the second taken image.
